(19) United States
(12) Patent Application Publication
(10) Pub. No.: US 2006/0116464 A1
(43) Pub. Date: Jun. 1, 2006

(54) Nanocomposites comprising telechelic polyesters and organoclays

(75) Inventors: Daniel Joseph Brunelle, Burnt Hills, NY (US); Martino Colonna, Bologna (IT); Corrado Berti, Ravenna (IT); Maurizio Fiorini, Bologna (IT)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/001,214

(22) Filed: Dec. 1, 2004

(51) Int. Cl. C08K 3/34; C08G 18/42

(52) U.S. Cl. 524/444; 524/604

(57) ABSTRACT

Nanocomposite compositions comprising organoclays and telechelic polyesters that contain sulfonate end groups were prepared that resulted in improved physical and mechanical properties.

### BACKGROUND

The invention relates generally to nanocomposites prepared by blending of telechelic ionomeric polyesters and organically modified clay. This invention also relates to processes for producing the nanocomposites and articles produced from the nanocomposites.

Layered-clay consists of metal silicates that are arranged in layered structures, which are stacked in an orderly fashion. Clay-based nanocomposites are obtained by admixing of extraneous materials such as polymers with the layered-clay to break the ordered layering into particles with size less than about 100 nm. This results in products with improved properties such as gas permeability properties, mechanical properties, glass transition temperature and the like. There are numerous examples of polymer-clay nanocomposites in the literature. The clay used to produce the nanocomposites may be an unmodified inorganic clay. Alternatively, the clay may be organically modified clay. The nanocomposites are typically made by blending of the clay with the polymer or blending the clay with a monomer followed by in situ polymerization.

It has been established in the art that in order to obtain high mechanical properties using nanocomposites, both sufficient exfoliation of the clay and strong adhesion of the polymer matrix to the layered silicate must be achieved, see for example Richard A. Vaia and Emmanuel P. Giannelis, Macromolecules, 1997, 30, 8000-8009. A nanocomposite prepared with randomly sulfonated poly(butylene terephthalate) and organically modified clay, where the sulfonate content was as low as 1% by mole with respect to terephthalate groups showed full exfoliation (Chisholm, B. J.; Moore, R. B.; Barber, G.; Khouri, F.; Hempsted, A.; Larsen, M.; Olson, E.; Kelley, J.; Balch, G.; Caraher, J. Macromolecules 2002, 35, 5508). The mechanical properties, in particular Young's modulus, of this nanocomposite increased with higher sulfonate content due to the higher number of electrostatic interaction between the polymer chain and the clay. However, only low molecular weight randomly sulfonated ionomeric poly(butylene terephthalate) were obtained by melt polymerization due to the very high melt viscosity of random ionomers which resulted in brittle materials.

Thus, there remains a need for nanocomposite polymer compositions which feature additional enhancements for use in the development of new applications for such materials. There is a need to discover novel nanocomposite polymer compositions and articles fabricated from them which present additional advantages relative to shown materials.

### BRIEF DESCRIPTION

In one aspect, the present invention provides novel nanocomposite polymer compositions comprising at least one telechelic polyester; and at least one organoclay, wherein the telechelic polyester comprises sulfonate end groups and structural units derived from at least one organic dicarboxylic acid and at least one diol.

In another aspect the present invention provides a method for the preparation of novel nanocomposite polymer compositions.

In yet another aspect the present invention provides an article comprising novel nanocomposite polymer compositions.

### DRAWINGS

These and other features, aspects, and advantages of the present invention will become better understood when the following detailed description is read with reference to the accompanying drawings in which like characters represent like parts throughout the drawings, wherein:

FIG. 1 shows the decrease in the molecular weight during the preparation of the nanocomposites as compared to the comparative example 1

FIGS. 2-5 show the exfoliation of the organoclay by the telechelic sulfonated poly(butyelene terephthalate) as compared to the non-ionic poly(butylene terephthalate).

FIG. 6 shows the DMTA chart of the telechelic sulfonated poly(butylene terephthalate) (examples 2,4 and 6) and comparative example 2 and PBT 195.

### DETAILED DESCRIPTION

The present invention may be understood more readily by reference to the following detailed description of preferred embodiments of the invention and the examples included therein. In the following specification and the claims which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “integer” means a whole number which includes zero. For example, the expression “n is an integer from 0 to 4” means “n” may be any whole number from 0 to 4 including 0.

Dispersion” or “dispersed” refers to the distribution of the organoclay particles in the polymer matrix.

“Intercalated” or “intercalate” refers to a higher degree of interaction between the polymer matrix and the organoclay as compared to mere dispersion of the organoclay in the polymer matrix. When the polymer matrix is said to intercalate the organoclay, the organoclay exhibits an increase in the interlayer spacing between adjacent platelet surfaces as compared to the starting organoclay.

“Delamination” refers to the process of separation of ordered layers of clay platelets through the interaction of the organoclay with the polymer matrix.

“Exfoliate” or “exfoliated” shall mean platelets dispersed mostly in an individual state throughout a polymer matrix material. Herein, “exfoliated” is used to denote the highest degree of separation of platelet particles. “Exfoliation” refers to the process by which an exfoliate is formed from an intercalated or otherwise dispersed organoclay within a polymer matrix.

“Nanocomposite(s)” and “nanocomposite composition(s)” refer to a polymer or copolymer having dispersed therein a plurality of individual clay platelets obtained from a layered clay material, wherein the individual particle sizes are less than about 100 nm.

“Matrix polymer”, “bulk polymer” or “bulk matrix polymer” refers to the continuous phase of a nanocomposite.

As noted, in one aspect the present invention provides novel nanocomposite polymer compositions comprising (a) at least one telechelic polyester; and (b) at least one organoclay, said telechelic polyester comprising sulfonate end groups and structural units derived from at least one organic dicarboxylic acid and at least one diol.

“Telechelic polymer” refers to a linear polymer whose end groups are functionalized with a suitable organic functional group such as carboxylates, sulfonates and the like. Telechelic polymers are well known in the literature. Their synthesis and applications have been discussed in, for e.g. Odian, G., Principles of Polymerization, 3^{rd} edition, Wiley-Interscience, New York, 1991, pg 427.

“End functionality” and “end-group functionality” are used interchangeably and refer to the functional group present on the ends of the polymer chain.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen: Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBᵣCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e.—CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph—), bromopropylphenyl (i.e. BrCH₂CH₂CH₂Ph—), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh—), aminocarbonylphenyl (i.e. NH₂COPh—), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph—), 4-mercaptomethylphemyl (i.e. 4-HSCH₂Ph—), 4-methylthiophenyl (i.e. 4—CH₃SPh—), methoxyphenyl, methoxycarbonylphenyloxy (e.g. methyl salicyl), nitromethylphenyl (i.e. —PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁O—), chloromethylcyclohexyl; 3-trifluorovinyl-2-cyclopropyl; 3-trichloromethylcyclohexyl (i.e. 3-CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopentyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆C₆H₁₁O—); 4-hydroxymethylcyclohexyl (i.e. 4-HOCH₂C₆H₁₁—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy (2-CH₃OCOC₆H₁₁O—), nitromethylcyclohexyl (i.e. NO₂CH₂C₆H₁₀—), trimethylsilylcyclohexyl, t-butyldimethylsilylcyclopentyl, 4-trimethoxysilylethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

The nanocomposite composition of the present invention comprises layered-clay material that are selected from the group consisting of natural, synthetic, and modified phyllosilicates. Natural clays include smectite clays such as montmorillonite, saponite, hectorite, mica, vermiculite, bentonite, nontronite, beidellite, volkonskoite, saponite, magadite, kenyaite, and the like. Synthetic clays include synthetic mica, synthetic saponite, synthetic hectorite, and the like. Modified clays include fluorinated montmorillonite, fluorinated mica, and the like. Suitable clays are available from various commercial sources such as Nanocor, Inc., Laviosa Chimnica Mineraria, Southern Clay Products, Kunimine Industries, Ltd., and Elementis Specialties, Inc.

Generally, the clay materials useful in this invention are layered materials that are an agglomeration of individual platelet particles that are closely stacked together in domains called tactoids. The individual platelet particles of the clays preferably have thickness of less than about 2nm and diameter in the range of from about 10 to about 3000 nm. The preferred clay materials are smectite clay minerals, particularly bentonite or montmorillonite.

The clay materials may comprise refined but unmodified clays, modified clays or mixtures of modified and unmodified clays. In an embodiment of the present invention, it is desirable to treat the selected clay material to facilitate separation of the agglomerates of platelet particles to individual platelet particles to form smaller-sized tactoids. Separating the platelet particles prior to incorporation into the polymer also improves the polymer/platelet interface. Any treatment that achieves the above goals may be used. Many clay treatments used to modify the clay for the purpose of improving dispersion of clay materials are known and may be used in the practice of this invention. The clay treatment may be conducted prior to, or during mixing the clay material with the polymer.

In an embodiment of this invention, a modified or treated layered clay material is prepared by the reaction of a swellable layered clay with an organic cation (to effect partial or complete cation exchange). If desired, two or more organic cations maybe used to treat the clay. The process to prepare the organoclays (modified or treated clays) may be conducted in a batch, semi-batch, or continuous manner.

Organic cations used to modify a clay material or a mixture of clay materials are derived from organic cation salts, such as polyalkyl ammonium salts, polyalkyl aminopyridinium salts, polyalkyl guanidinium salts, polyalkyl imidazolium salts, phosphonium salts, sulfonium salts, and mixtures thereof. “Polyalkyl” refers to a central atom substituted by alkyl groups but may contain hydrogens to fulfill the valence of the central atom as well. Examples of polyalkyl ammonium salts, include tetramethyl ammonium, hexyl ammonium, butyl ammonium, bis(2-hydroxyethyl) dimethyl ammonium, hexyl benzyl dimethyl ammonium, benzyl trimethyl ammonium, butyl benzyl dimethyl ammonium, tetrabutyl ammonium, di(2-hydroxyethyl) ammonium, dodecyl ammonium, octadecyl trimethyl ammonium, bis(2-hydroxyethyl) octadecyl methyl ammonium, octadecyl benzyl dimethyl ammonium and the like; examples of polyalkylaminopyridinium salts include p-dimethylamino N-methyl pyridinium salts, o-dimethylaminopyridinium salts, N-alkyl pyridinium salts and the like; polyalkylguanidinium salts such as hexaalkyl guanidinium salts; imidazolium salts such as 1,2-dimethyl-3-N-hexadecylimidazolium salt, benzimidazolium salts, and the like; and phosphonium ions such as tetrabutyl phosphonium, trioctyl octadecyl phosphonium, tetraoctyl phosphonium, octadecyl triphenyl phosphonium, and the like or mixtures thereof.

Illustrative examples of suitable polyalkoxylated ammonium compounds include the hydrochloride salts of polyalkoxylated amines such as JEFFAMINE (of Huntsman Chemical), namely, JEFFAMINE-506 and JEFFAMINE 505, and an amine available under the trade name ETHOMEEN (of Akzo Chemie America), namely, ETHOMEEN 18/25, which is octadecyl bis(polyoxyethylene[15])amine, wherein the numbers in brackets refer to the total number of ethylene oxide units. A further illustrative example of a suitable polyalkoxylated ammonium compound is ETHOQUAD 18/25 (of Akzo Chemie America), which is octadecyl methyl bis(polyoxyethylene[15]) ammonium chloride, wherein the numbers in brackets refer to the total number of ethylene oxide units. A preferred modified clay that is used in this invention is the montmorillonite modified with a quarternary ammonium salt bearing two dihydrogenated tallow and two dimethyl groups; and is commercially available as Dellite 72T from Laviosa Chemicals, Italy or available as Claytone HY from Southern Clay Products, Inc., Gonzales, Tex.

Preferred telechelic polymers that are used to prepare the polymer/clay nanocomposites of this invention include telechelic polyesters that comprise structural units derived from at least one dicarboxylic acid and at least one diol unit. Typical dicarboxylic acids are selected from the group consisting of terephthalic acid, isophthalic acid, naphthalenedicarboxylic acid, 1,4-cyclohexanedicarboxylic acid. The various isomers of naphthalenedicarboxylic acid such as 1,4-, 2,6- and the like may be used. The 1,4-cyclohexanedicarboxylic acid may be in the cis form, trans form or cis/trans mixture. In a preferred embodiment of the present invention, the dicarboxylic acid of choice is chosen from terephthalic acid and 1,4-cyclohexanedicarboxylic acid.

The dicarboxylic acid component of the polyester may optionally be modified with up to about 50 mole percent of one or more different dicarboxylic acids. Such additional dicarboxylic acids include but are not limited to succinic acid, glutaric acid, adipic acid, azelaic acid, diphenyl-4,4′-dicarboxylic acid, phenylenedi(oxyacetic acid), and mixtures thereof.

Typical diols used to prepare the telechelic polyester are selected from the group consisting of ethylene glycol, 1,3-propanediol, 1,4-butanediol, 1,6-hexanediol, 1,4-cyclohexanedimethanol, diethylene glycol, and mixtures thereof. The diol component may optionally be modified with upto about 50 mole percent of one or more different diols that are selected from the group consisting of triethylene glycol, 1,5-pentanediol, bis(4-hydroxycyclohexyl)-propane, 1,4-di-(2-hydroxyethoxy)-benzene, 2,2,4-trimethylpentane diol, 2,2-bis-(4-hydroxypropoxyphenyl)-propane, and mixtures thereof. In a preferred embodiment of the present invention, the diol is 1,4-butanediol.

Telechelic polymers that comprise the nanocomposites of the present invention possess end functionalities that typically comprise sulfonate groups, carboxylate groups, alcohol groups and mixtures thereof. The end functionalities may arise as a result of the polymerization reaction or may be introduced through the use of a separate reactant. In a typical embodiment of the present invention, the polymer chains contain more than about 50 mole percent sulfonate end groups with respect to all the end groups present on the polymer chains.

The telechelic polymer of the present invention may be synthesized by the polymerization of the dicarboxylic acid with substantially equimolar amounts of diol followed by end-capping with a suitable end-capping agent. A typical end-capping agent may be a compound containing sulfonate group with a monocarboxylic acid or a primary monoalcohol. An example of this compound is a sulfoaromatic carboxylic acid of the formula (I) 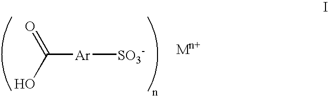
where Ar is unsubstituted or substituted arylene, where the substitution is C₁-C₃ hydrocarbon; M is an alkali metal, alkaline earth metal, or transition metal; and n is 1 or 2. A preferred end-capping agent is 3-carboxy benzenesulfonic acid, sodium salt (CAS # 17625-03-5) that is available commercially from Aldrich Chemical Co. Another preferred end-capping agent is the reaction product of an alkane diol with an alkane sultone, which has the formula (II): 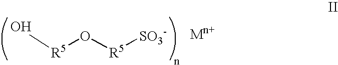
wherein R⁵ and R⁶ are independently at each occurrence a C₁-C₁₂ aliphatic radical, a C₃-C₁₂cycloaliphatic radical, or a C₃-C₁₂ aromatic radical.

In an alternate preferred embodiment of the present invention, the diol is reacted first with the sulfoaromatic carboxylic acid metal salt or the alkane sultone in an inert solvent or as a neat reaction to give rise to a monofunctional sulfonate product. The product from the reaction in the first step is allowed to react with diol and dicarboxylate ester in the same reaction vessel in an inert solvent or as a neat reaction to obtain polyester that is end-capped with sulfonate groups. Optional transesterification catalysts and cocatalysts may be added to the reaction mixture to improve the kinetics of the both the reactions. Typical reaction temperatures for both the reactions are greater than 150° C. Polymers are purified by dissolution in a suitable solvent such as methylene chloride and precipitation into a non-solvent such as methanol, filtration, isolation, repeating the steps involved in the purification process multiple times, and vacuum drying the resulting telechelic polyester. Other purification methods known to those skilled in the art may be used to obtain pure telechelic polyesters. Typically, the polymers are not purified, but are used directly as obtained from the melt reactor.

Polymers synthesized using the methods described provide almost 90 mole percent incorporation of the sulfonate groups into the polymer chain as an end group, with respect to the total amount of sulfonate groups in the initial reactant feed. Also, the polymers consist of at least 50 mole percent of sulfonate end groups, with respect to the total end groups present.

The polymer/clay nanocomposites of this invention may be prepared with the functionalized matrix polymer by methods known to those skilled in the art. In a preferred embodiment of the invention, the polymer/clay nanocomposites are prepared by melt mixing in a suitable mixing instrument capable of heating to melt temperatures of the polymer. In one embodiment of the invention, the mixing is done in a Brabender mixer in a temperature range from about 180° C. to about 300° C., more preferably from about 225° C. to about 275° C. and most preferably from about 240° C. to about 270° C. A typical nanocomposite composition comprising polymer and modified clay mixtures contain modified clay in the range of from about 0.1 weight percent to about 10 weight percent. In a preferred embodiment of the present invention, the modified clay is present in the range of from about 1 weight percent to about 7 weight percent, and more preferably, from about 2 weight percent to about 7 weight percent.

The polymer/clay nanocomposite compositions may further comprise one or more additives. The additive may be present in quantities of up to about 80% by weight, and more preferably in quantities of from 0.00001 to about 60% by weight, based on the weight of the composition comprising the additive. These additives include such materials as thermal stabilizers, antioxidants, UV stabilizers, plasticizers, visual effect enhancers, extenders, antistatic agents, catalyst quenchers, mold releasing agents, fire retardants, blowing agents, impact modifiers, processing aids, other oligomeric species, and other polymeric species. The different additives that can be incorporated into the polymer/clay nanocomposites of the present invention are typically those that are commonly used in resin compounding and are known to those skilled in the art.

The nanocomposite polymer compositions of the present invention may be formed into articles by conventional plastic processing techniques. Molded articles may be made by compression molding, blow molding, injection molding or such molding techniques known to those skilled in the art. Articles prepared from the nanocomposites of the present invention include, but are not limited to film, sheet, pipes, tubes, profiles, molded articles, performs, stretch blow molded films and containers, injection blow molded containers, extrusion blow molded films and containers, thermoformed articles and the like. Articles prepared from the compositions of the present invention may be used in applications that require materials with low glass transition temperature and high heat resistance such as automotive applications. In one embodiment the present invention provides an article comprising at least one nanocomposite polymer composition, wherein said composition comprises at least one sulfonated telechelic polyester, and at least one organoclay, wherein said telechelic polyester comprises sulfonate end groups and structural units derived from at least one organic dicarboxylic acid and at least one diol, wherein said article is an automotive part. Automotive parts are exemplified by body panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards.

### EXAMPLES

General Procedure for Examples 2-7 and Comparative Examples 1 and 7: The following examples are set forth to provide those of ordinary skill in the art with a detailed description of how the methods claimed herein are evaluated, and are not intended to limit the scope of what the inventors regard as their invention. Unless indicated otherwise, parts are by weight, temperature is in ° C. Transmission Electron Micrographs were obtained on a TEM JEOL JEM2010 instrument. Samples were prepared with microtome Leica Ultracut UCT with EM-FCS cooling.

Molecular weights are reported as weight average (M_{w}) molecular weight and were determined by gel permeation chromatography (GPC) analysis, using polystyrene molecular weight standards to construct a broad standard calibration curve against which polymer molecular weights were determined. The temperature of the gel permeation columns was 25° C. and the mobile phase was chloroform with 5% v/v hexafluoro isopropanol.

Physical and mechanical properties were determined using Rheometric Scientific DMTA IV Dynamic Mechanic Thermo analysis instrument with a dual cantilever testing geometry. Typical test samples were bars that were injected molded at 275° C. using a Minimax Molder. The testing was done at a frequency of 3 Hz and temperature range was from −50° C. to 200° C. at a rate of 3° C./minute.

In a 1.8 L stainless steel pilot plant reactor equipped with a stirrer, 3-carboxybenzene sulfonic acid sodium salt was added to a large excess of 1,4-butane diol and catalytic amounts of tetrabutoxy titanate was then added to this mixture while stirring. The temperature of the reaction mixture was then increased and held at 230° C. for 1 hour. During this time, the 3-carboxybenzene sulfonic acid sodium salt dissolved completely in 1,4-butane diol. The reaction mixture was then cooled down to 180° C. and dimethyl terephthalate was added. The temperature was then raised to 215° C. and held at that temperature for 2 hours. Then the temperature was raised to 245° C. over a 30 minute period. A vacuum was then applied to the system and the pressure was maintained at 0.1 mbar for 105 minutes to enhance removal of methanol from the reaction vessel. The final polymer was obtained as a pale yellow viscous melt which crystallized to a white solid rapidly. The preparation of the telechelic sulfonated polyesters is also described in a recent U.S. patent application Ser. No. 10/869,715.

Polymer/Clay nanocomposites were prepared in a Brabender Plasticorder 2000 equipped with an electrically-heated mixer. A mixture that consisted of organoclay and telechelic polymer was added to the blender. The internal temperature of the mixer was maintained at 245° C. and the mixing speed was 60 rpm. Blending was done over a 30 minute period. After the blending, the nanocomposites were obtained as transparent melt. Some degradation of the polymer was observed during this process as evidenced by GPC results.

TABLE 1
Results of nanocomposite preparation using different
clays and different polymer ionic contents

| | | | | Clay | |
|---|---|---|---|---|---|
| | Polymer | | Blending | amount | |
| | used * | Clay used ** | time | (% w/w) | Mw |
| Comparative | PBT195 | Dellite HPS | 30 min | 5 | 32700 |
| Example 1 | | | | | |
| Comparative | PBT195 | Dellite 72T | 30 min | 5 | 36700 |
| Example 2 | | | | | |
| Comparative | PBT195 | Imidazolium | 30 min | 5 | 49900 |
| Example 3 | | | | | |
| Example 1 | 3% tel | Dellite HPS | 30 min | 5 | 31800 |
| Example 2 | 3% tel | Dellite 72T | 30 min | 5 | 27500 |
| Example 3 | 0.5% tel | Dellite 72T | 30 min | 5 | 51000 |
| Example 4 | 1% tel | Dellite 72T | 30 min | 5 | 42400 |
| Example 5 | 2% tel | Dellite 72T | 30 min | 5 | 36000 |
| Example 6 | 5% tel | Dellite 72T | 10 min | 5 | 23500 |
| Example 7 | 3% tel | Imidazolium | 30 min | 5 | 39800 |

* PBT195 refers to poly(butylene terephthalate) of molecular weight 54000. % tel refers to telechelic sulfonated poly(butylene terephthalate) containing that amount of sulfonate end groups as compared to the total end groups.
** The clays listed here are all trade names of organoclays that are available from Laviosa Chemicals, Italy; while Imidazolium refers to montmorillonite modified with 1,2-dimethyl 3-N-hexadecylimidazlium chloride.

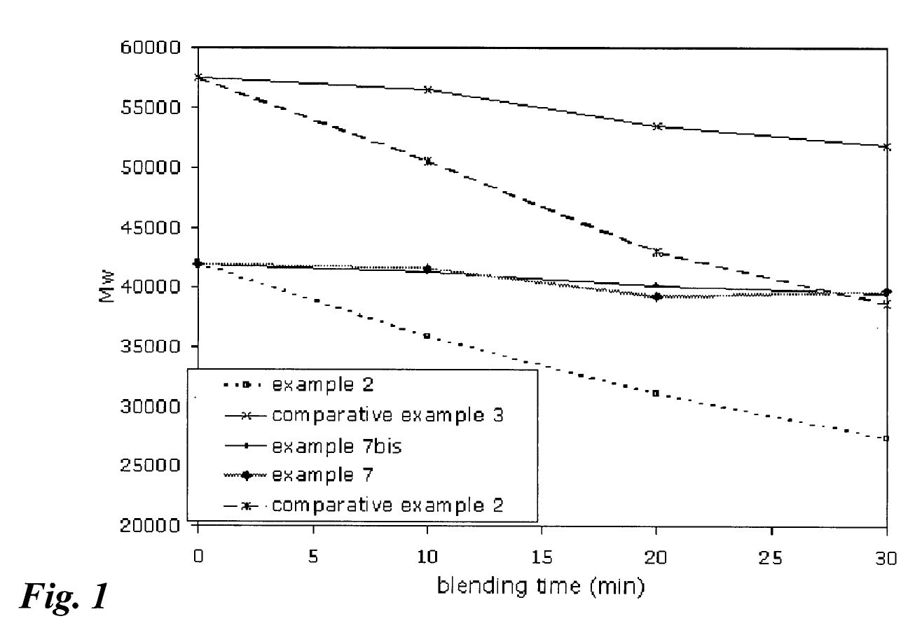

FIG. 1 shows the decrease in the molecular weight during the preparation of the nanocomposites as compared to the comparative example 1

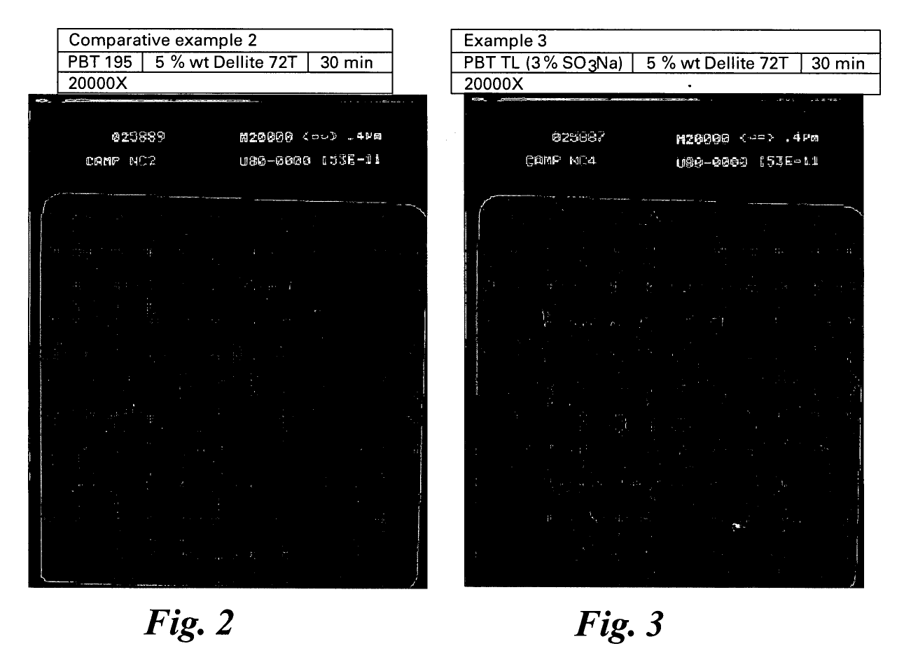

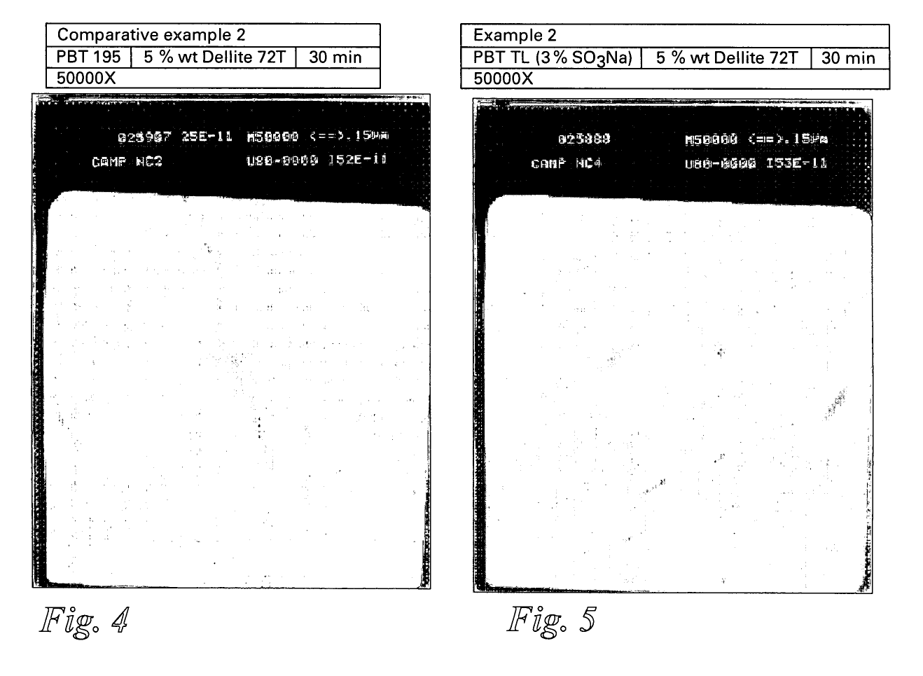

FIGS. 2-5 shows the TEM micrographs of the nanocomposites prepared from the organoclay and the telechelic sulfonated poly(butyelene terephthalate) as compared to the nanocomposite prepared from the organoclay and the non-ionic poly(butylene terephthalate).

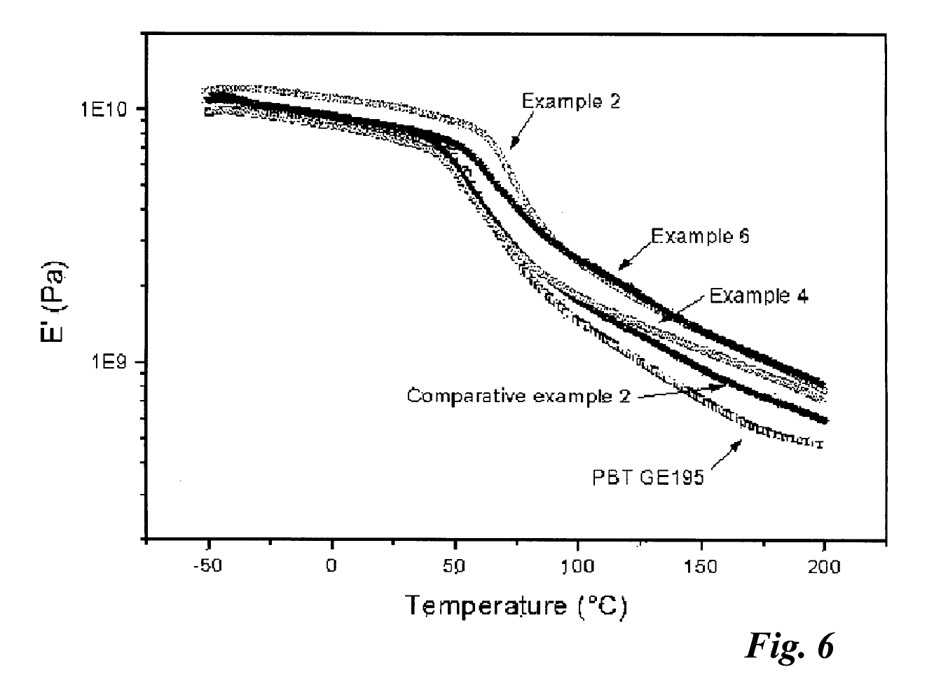

FIG. 6 shows the DMTA chart of the telechelic sulfonated poly(butylene terephthalate) (examples 2,4 and 6) and comparative example 2 and PBT 195 polymer by itself.

FIG. 1 shows that there is some decrease in the molecular weight of the polymer with the telechelic polymer as compared to the non-telechelic polymer. The TEM micrographs shown in FIGS. 2-5 show that the extent of exfoliation is much better when the nanocomposites were prepared with telechelic sulfonated poly(butylene terephthalate). DMTA traces shown in FIG. 6 shows the increase in the heat distortion temperature (Temperature at an E′ value of 10⁻⁹) when nancomposites were prepared from telechelic poly(butylene terephthalate). The embodiments and examples given show that nanocomposites prepared using telechelic ionomeric polyesters surprisingly show improved properties over non-ionomeric polyesters or randomly ionomeric polyesters.

The invention has been described in detail with particular reference to preferred embodiments thereof, but it will be understood by those skilled in the art that variations and modifications can be effected within the spirit and scope of the invention.

1. A nanocomposite polymer composition comprising:
a) at least one sulfonated telechelic polyester; and
b) at least one organoclay;
said telechelic polyester comprising sulfonate end groups and structural units derived from at least one organic dicarboxylic acid and at least one diol.

2. The nanocomposite polymer composition according to claim 1 wherein said sulfonate groups are present in an amount corresponding to from about 0.1 mole percent to about 10 mole percent based on a total number of moles of structural units derived from organic dicarboxylic acids and diols.

3. The nanocomposite polymer composition according to claim 2 wherein said sulfonate groups are present in an amount corresponding to from about 0.1 mole percent to about 5 mole percent.

4. The composition according to claim 1 wherein the organoclay is an organically modified inorganic clay selected from the group consisting of montmorillonite, saponite, hectorite, mica, vermiculite, bentonite, nontronite, beidellite, volkonskoite, saponite, magadite, kenyaite, synthetic mica, synthetic saponite, and synthetic hectorite.

5. The composition according to claim 4 wherein the organoclay comprises at least one organic species selected from the group consisting of polyalkyl ammonium salts, poly alkylaminopyridinium salts, polyalkylguanidinium salts, polyalkylimidazolium salts, phosphonium salts, sulfonium salts, and mixtures thereof.

6. The composition according to claim 1 wherein the organoclay is present in an amount corresponding to from about 0.1 weight percent to about 10 weight percent based on a total weight of the nanocomposite polymer composition.

7. The composition according to claim 6 wherein the organoclay is present in an amount corresponding to from about 0.5 weight percent to about 10 weight percent.

8. The composition according to claim 7 wherein the organoclay is present in an amount corresponding to from about 0.5 weight percent to about 7 weight percent.

9. A method for making a nanocomposites polymer composition, said method comprising contacting a mixture comprising at least one organoclay and at least one sulfonated telechelic polyester, said telechelic polyester comprising sulfonate end groups and structural units derived from at least one organic dicarboxylic acid and at least one diol, said contacting comprising agitating said mixture at a temperature in a range between about 180° C. and about 300° C. until a homogeneous melt is obtained.

10. The method according to claim 9 wherein said sulfonate groups are present in an amount corresponding to from about 0.1 mole percent to about 10 mole percent based on a total number of moles of structural units derived from organic dicarboxylic acids and diols.

11. The method according to claim 10 wherein said sulfonate groups are present in an amount corresponding to from about 0.1 mole percent to about 5 mole percent.

12. The method according to claim 9 wherein the organoclay is an organically modified inorganic clay selected from the group consisting of montmorillonite, saponite, hectorite, mica, vermiculite, bentonite, nontronite, beidellite, volkonskoite, saponite, magadite, kenyaite, synthetic mica, synthetic saponite, and synthetic hectorite.

13. The method according to claim 12 wherein the organoclay comprises at least one organic species selected from the group consisting of polyalkyl ammonium salts, poly alkylaminopyridinium salts, polyalkylguanidinium salts, polyalkylimidazolium salts, phosphonium salts, sulfonium salts, and mixtures thereof.

14. The method according to claim 9 wherein the organoclay is present in an amount corresponding to from about 0.1 weight percent to about 10 weight percent based on a total weight of the nanocomposite polymer composition.

15. The method according to claim 13 wherein the organoclay is present in an amount corresponding to from about 1 weight percent to about 10 weight percent.

16. The method according to claim 15 wherein the organoclay is present in an amount corresponding to from about 2 weight percent to about 7 weight percent.

17. The method according to claim 9 where said contacting is carried out in an extruder.

18. The method according to claim 17 wherein said extruder is a twin-screw extruder.

19. An article comprising a nanocomposite polymer composition, said composition comprising:
a) at least one sulfonated telechelic polyester; and
b) at least one organo clay
said telechelic polyester comprising sulfonate end groups and structural units derived from at least one organic dicarboxylic acid and at least one diol.

20. The article according to claim 19 which is fabricated by at least one molding technique selected from the group consisiting of compression molding, blow molding, and injection molding.

21. The article of claim 19 which is an automotive part selected from the group consisting of body panels, quarter panels, rocker panels, trim, fenders, doors, decklids, trunklids, hoods, bonnets, roofs, bumpers, fascia, grilles, mirror housings, pillar. appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards.
